(19) United States
(12) Patent Application Publication
(10) Pub. No.: US 2024/0310664 A1
(43) Pub. Date: Sep. 19, 2024

(54) OPTICAL ISOLATORS FOR PHOTONIC INTEGRATED CIRCUITS

(71) Applicant: Analog Photonics LLC, Boston, MA (US)

(72) Inventors: Matthew Byrd, Arlington, MA (US); Michael Robert Watts, Hingham, MA (US); Jordan Goldstein, Boston, MA (US); Skylar Deckoff-Jones, Boston, MA (US); Michael Zylstra, Dedham, MA (US)

(73) Assignee: Analog Photonics LLC, Boston, MA (US)

(21) Appl. No.: 18/602,726

(22) Filed: Mar. 12, 2024

Related U.S. Application Data
(60) Provisional application No. 63/489,883, filed on Mar. 13, 2023.

(51) Int. Cl. G02F 1/095

(52) U.S. Cl. CPC G02F 1/0955

(57) ABSTRACT

An apparatus comprises a photonic integrated circuit comprising a first optical coupler coupled to an optical source and a second optical coupler coupled to one or more photonic circuit elements integrated in the photonic integrated circuit; and a non-reciprocal optical element optically coupled to the first optical coupler and the second optical coupler. At least one of the first optical coupler or the second optical coupler is configured as a polarization-sensitive optical antenna that has an angular radiation function comprising at least (1) a peak intensity of a transverse magnetic optical field associated with a first angular direction, and (2) a peak intensity of a transverse electric optical field associated with a second angular direction different from the first angular direction.

### CROSS-REFERENCE TO RELATED APPLICATION(S)

This application claims priority to and the benefit of U.S. Provisional Application Ser. No. 63/489,883, entitled “OPTICAL ISOLATORS FOR PHOTONIC INTEGRATED CIRCUITS,” filed Mar. 13, 2023, the entire disclosure of which is hereby incorporated by reference.

### TECHNICAL FIELD

This disclosure relates to optical isolators for photonic integrated circuits.

### BACKGROUND

Photonic integrated circuits (PICs) are integrated circuits that transmit optical signals (e.g., in optical waveguides). A PIC may comprise one or more optical sources (e.g., a laser) that generate optical signals that can then be routed by optical waveguides in the PIC. PICs may also be configured to emit and/or receive optical signals that propagate off-chip. In general, an optical isolator can be used to optically isolate a component (e.g., a laser or an optical cavity) from reflections caused by optical elements of a system located downstream of the component. In some examples, optical isolation may be used to reduce instabilities in an optical source.

### SUMMARY

In one aspect, in general, an apparatus comprises: a photonic integrated circuit comprising a first optical coupler coupled to an optical source and a second optical coupler coupled to one or more photonic circuit elements integrated in the photonic integrated circuit; and a non-reciprocal optical element optically coupled to the first optical coupler and the second optical coupler. At least one of the first optical coupler or the second optical coupler is configured as a polarization-sensitive optical antenna that has an angular radiation function comprising at least (1) a peak intensity of a transverse magnetic optical field associated with a first angular direction, and (2) a peak intensity of a transverse electric optical field associated with a second angular direction different from the first angular direction.

Aspects can include one or more of the following features.

The non-reciprocal optical element comprises a magneto-optic material.

The apparatus further comprises a magnetic field source applying a magnetic field in the vicinity of at least a portion of the magneto-optical material.

The first optical coupler is configured as a polarization-sensitive transmitting optical antenna that has an angular radiation function comprising at least (1) a peak intensity of a transverse magnetic optical field associated with transmitting in a first angular direction, and (2) a peak intensity of a transverse electric optical field associated with transmitting in a second angular direction different from the first angular direction; and the second optical coupler is configured as a polarization-sensitive receiving optical antenna that has an angular radiation function comprising at least (1) a peak intensity of a transverse magnetic optical field associated with receiving in a first angular direction, and (2) a peak intensity of a transverse electric optical field associated with receiving in a second angular direction different from the first angular direction.

The first optical coupler comprises a first optical phased array, and the second optical coupler comprises a second optical phased array.

The first optical phased array comprises a plurality of optical gratings coupled to respective phase shifters.

In another aspect, in general, an apparatus comprises: a photonic integrated circuit comprising a first optical coupler coupled to an optical source and a second optical coupler coupled to one or more photonic circuit elements integrated in the photonic integrated circuit; a non-reciprocal optical element; and a reflecting optical arrangement comprising at least two reflecting surfaces. The reflecting surfaces are all mechanically secured relative to each other, and the reflecting surfaces are arranged to optically couple the first optical coupler and the second optical coupler using an optical wave propagation path that is substantially parallel the first optical coupler at one end and substantially parallel to the second optical coupler at another end, and that propagates through the non-reciprocal optical element.

Aspects can include one or more of the following features.

The non-reciprocal optical element comprises a magneto-optic material.

The apparatus further comprises a magnetic field source applying a magnetic field in the vicinity of at least a portion of the magneto-optical material.

The reflecting optical arrangement comprises at least two mirrors mounted to a common rigid structure.

The reflecting optical arrangement comprises at least one prism.

In another aspect, in general, an apparatus comprises: a non-reciprocal optical element; a first lens; a second lens; and a photonic integrated circuit comprising a substrate having an etched cavity configured to include a first etched portion shaped to mechanically support the first lens using a set of two or more contact surfaces etched into the substrate approximately aligned with crystallographic planes of the substrate, a second etched portion shaped to mechanically support the second lens using a set of two or more contact surfaces etched into the substrate approximately aligned with crystallographic planes of the substrate, and a third etched portion shaped to mechanically support at least a portion of the non-reciprocal optical element.

Aspects can include one or more of the following features.

The non-reciprocal optical element comprises a magneto-optic material.

The apparatus further comprises a magnetic field source applying a magnetic field in the vicinity of at least a portion of the magneto-optical material.

The substrate comprises silicon.

In another aspect, in general, an apparatus comprises: a photonic integrated circuit comprising a first optical coupler coupled to an optical source and a second optical coupler coupled to one or more photonic circuit elements integrated in the photonic integrated circuit; and an optically isolating element coupled to the first optical coupler and to the second optical coupler, the optically isolating element comprising one or more non-reciprocal optical elements that collectively rotate a polarization of light by a multiple of 90 degrees, and at least one polarizer.

Aspects can include one or more of the following features.

The optically isolating element is at least partially located within a substrate trench of the photonic integrated circuit.

The one or more non-reciprocal optical elements comprise a first Faraday rotator that rotates a polarization of light by 45 degrees, a second Faraday rotator that rotates a polarization of light by 45 degrees, and the at least one polarizer is located between the first Faraday rotator and the second Faraday rotator.

At least one of the first optical coupler or the second optical coupler are configured to modify a mode diameter of light.

The apparatus further comprises a polarization rotator, coupled to the second optical coupler, that rotates a polarization of light.

Aspects can have one or more of the following advantages.

Various implementations of optically isolating photonic systems (OIPSs) are disclosed herein. In some examples, OIPSs can reduce the number of optical components that are externally coupled outside of a photonic integrated circuit (PIC) and can facilitate alignment of one or more optical components of an optically isolating element (OIE) with optical couplers located on the PIC. For example, the one or more optical components of the OIE may be located within a cavity of the PIC, above the PIC, or to the side of the PIC. The techniques and systems disclosed may enable optical isolation of optical components in a compact form factor with increased optical alignment stability. In general, OIPS may be used to stabilize a variety of optical systems that operate using optical waves that have a peak wavelength that falls in a particular range (e.g., between about 100 nm to about 1 mm, or some subrange thereof), also referred to herein as simply “light.”

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example optically isolating photonic system.

FIG. 2 is a schematic diagram of an example optically isolating photonic system.

FIG. 3 is a schematic diagram of an example optically isolating photonic system.

FIG. 4 is a schematic diagram of an example optically isolating photonic system.

FIG. 5 is a schematic diagram of an example optically isolating photonic system.

FIGS. 6A and 6B are schematic diagrams of an example optically isolating photonic system.

FIG. 7A is a schematic diagram of a portion of an example optically isolating photonic system.

FIG. 7B is a schematic diagram of a portion of an example optically isolating photonic system.

FIG. 7C is a schematic diagram of a portion of an example optically isolating photonic system.

FIG. 8 is a schematic diagram of an example optically isolating photonic system.

FIG. 9 is a schematic diagram of a prophetic example of ray-tracing in an example optically isolating photonic system.

FIG. 10 is a schematic diagram of an example optically isolating photonic system.

FIG. 11 is a schematic diagram of an example optically isolating element.

FIG. 12 is a schematic diagram of an example optically isolating photonic system with polarization states shown for forward and backward propagation.

FIG. 13 is a schematic diagram of an example optically isolating photonic system with polarization states shown for forward and backward propagation.

FIG. 14 is a schematic diagram of an example optically isolating photonic system with polarization states shown for forward and backward propagation.

FIGS. 15A and 15B are schematic diagrams of example large mode-field diameter edge couplers.

FIG. 16 is a plot of a prophetic example of coupling efficiency between optical beams of varying width as a function of distance.

### DETAILED DESCRIPTION

In optics, reciprocity is a principle that describes certain symmetries associated with the manner in which light propagates in certain media (i.e., a reciprocal medium). However, not all media are reciprocal. A non-reciprocal medium can be used within devices called optical isolators to enable light to propagate without significant loss in one direction through an optical isolator but not in the opposite direction through the optical isolator. In some examples, an optical isolator comprises a non-reciprocal optical element and two polarization elements (e.g., polarizers or polarizing beam splitters) on opposite sides of the non-reciprocal optical element with their respective polarization axes aligned in a particular manner with respect to each other. Other arrangements of optical isolators are also possible, as described in more detail below. As used herein, an optically isolating element (OIE) comprises a non-reciprocal optical element and is a portion of an optical isolator or is an optical isolator itself. Thus, in some examples, an OIE further comprises additional optical elements (e.g., polarization elements) that collectively form an optical isolator.

In some examples of non-reciprocity, light that is characterized by a polarization and that traverses without significant loss through a non-reciprocal optical element twice, once when travelling from a first point to a second point and once when travelling from the second point to the first point, is not returned to the same polarization state. In some examples, a non-reciprocal optical element is a Faraday rotator composed of a magneto-optic material that, when placed in a magnetic field, applies Faraday rotation to light propagating within the non-reciprocal optical element, where the amount of rotation is dependent on the strength of the magnetic field and is in a direction that is determined with respect to the Faraday rotator rather than with respect to the direction of propagation of the light. Some photonic integrated circuit (PIC) technologies (e.g., silicon photonic platforms) may lack magneto-optic materials and may instead use an OIE that is not located on the PIC. Thus, one challenge of maintaining optical isolation in some PICs can be achieving a compact photonic system that couples light (e.g., provided by a heterogeneously integrated laser located on the PIC) from a first waveguide, through an OIE, and into a second waveguide. Herein various example implementations of an optically isolating photonic system (OIPS) are disclosed that address challenges associated with optical isolation in photonic systems.

In some example implementations of an OIPS, emitters and/or receivers (e.g., optical phased arrays) located on a PIC emit and receive light out of and into the PIC. Each optical phased array may comprise a number of optical gratings that are each coupled to respective phase shifters and that each emit light with adjustable phase and/or intensity, thus allowing the optical phased arrays to be configured to perform additional functions. For example, each optical phased array may be configured to output light, along a specified direction, that has an angular radiation function (i.e., pattern) comprising a peak intensity associated with a transverse magnetic optical field or a transverse electric optical field.

In general, optical phased arrays can be configured to output light that is combination of a transverse electric optical field and a transverse magnetic optical field. The use of an emitter located on the PIC allows for the light transmitted out of the PIC to be collimated without additional optics (e.g., lenses), while the use of a receiver located on the PIC allows for the light received by the PIC to be focused without additional optics. Thus, emitters and receivers located on the PIC can substantially reduce complexity and alignment requirements compared to photonic systems that utilize one or more lenses not located on the PIC.

In some examples, emitters and receivers located on a PIC can be polarization-sensitive, such that some or all of the polarizer functionality of an optical isolator can be integrated into the emitter and/or receiver in order to simplify the OIPS. In such examples, the polarization-sensitive emitters (PSEs) and the polarization-sensitive receivers (PSRs) can behave as polarizers located before and after a non-reciprocal optical element (e.g., a Faraday rotator), such that only light traveling in the forward direction will be allowed to travel through the OIPS. In order to achieve such polarization filtering, a polarization-sensitive emitter and a polarization-sensitive receiver may be rotated with respect to one another.

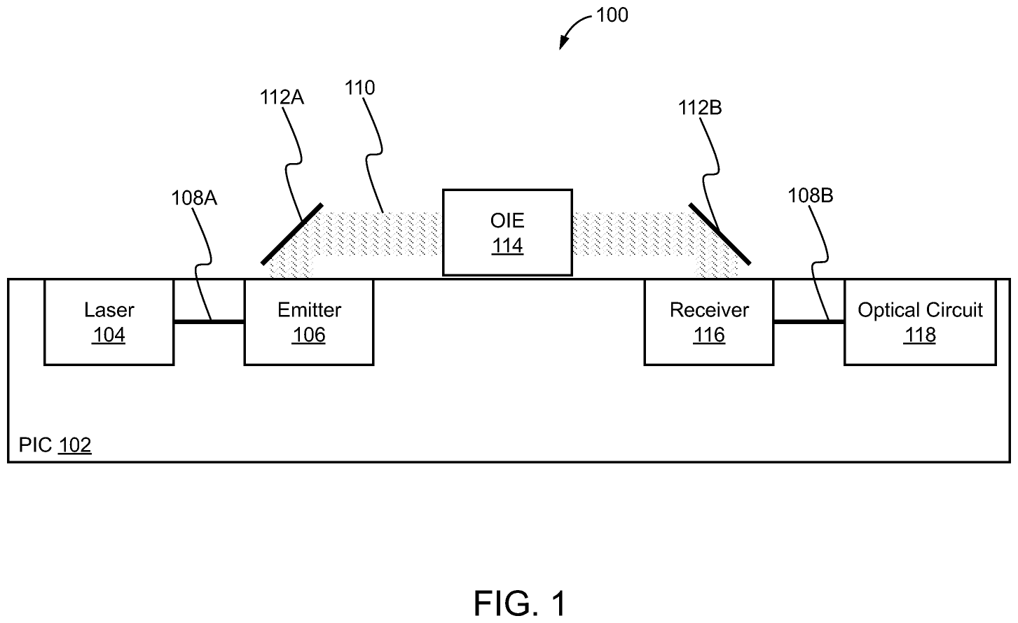

FIG. 1 shows a side view of an example OIPS 100 comprising a PIC 102. The PIC 102 comprises a laser 104 (or other coherent optical source) optically coupled to an emitter 106 by a first waveguide 108A. The emitter 106 vertically emits free-space light 110 from the PIC 102 that is subsequently reflected off of a first mirror 112A and through an OIE 114 comprising a non-reciprocal optical element (not shown). After the OIE 114, the free-space light 110 is reflected off of a second mirror 112B and is optically coupled to a receiver 116 located on the PIC 102. The receiver 116 is optically coupled to an optical circuit 118 by a second waveguide 108B, where the optical circuit 118 comprises additional PIC elements. In order to reduce pointing noise in the free-space light 110, the first mirror 112A and the second mirror 112B may be mechanically secured relative to each other (e.g., by mounting them both to a common rigid structure). In other example implementations of an OIPS, the first mirror 112A and the second mirror 112B can be replaced with a prism, which may reduce the alignment complexity of the OIPS. In some examples, the emitter 106 and/or the receiver 116 are polarization-sensitive, while in other examples the OIE 114 comprises polarization elements.

In some examples, an OIPS can be configured such that a first polarizer (e.g., a PSE) located before the non-reciprocal optical element, and a second polarizer (e.g., a PSR) located after the non-reciprocal optical element, have their axes arranged at an angle of 45 degrees to each other. In such a configuration, the non-reciprocal optical element can be configured to apply, upon each pass of the light through the non-reciprocal optical element, a polarization rotation of 45 degrees to the light. Such rotation occurs regardless of the direction of propagation of the light. Thus, light can pass through both polarizers in a forward direction without substantial loss, but will be rotated by 90 degrees in the backward direction after propagating through the non-reciprocal optical element twice (i.e., after propagation in the forward direction followed by propagation in the backward direction), and will consequently be blocked by the first polarizer.

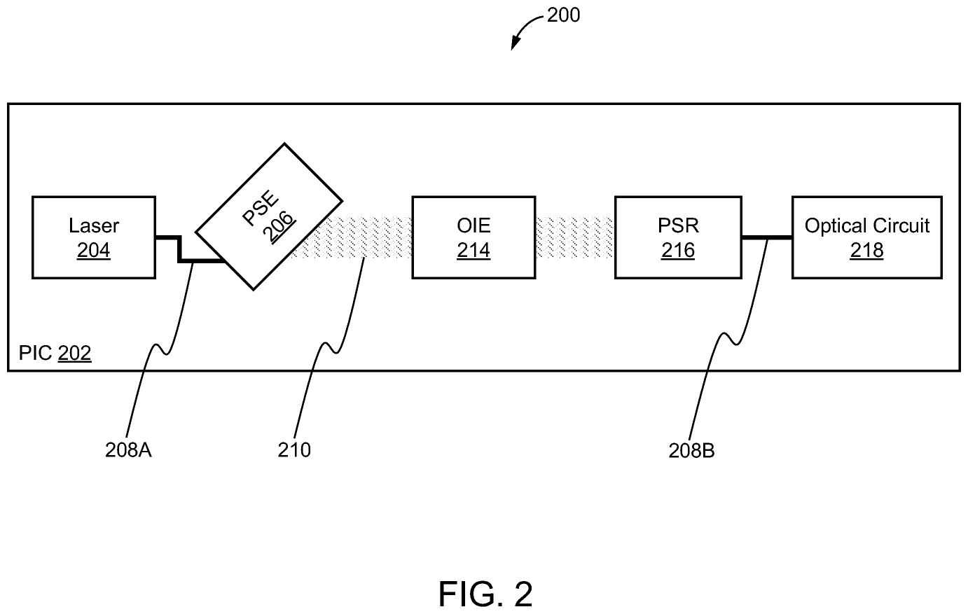

FIG. 2 shows a top view of an example OIPS 200 comprising a PIC 202. The PIC 202 comprises a laser 204 optically coupled to a PSE 206 by a first waveguide 208A. The PSE 206 vertically emits (i.e., out of the page) free-space light 210 that is subsequently reflected off of a first mirror (not shown) and through an OIE 214 (e.g., a Faraday rotator). After the OIE 214, the free-space light 210 is reflected off of a second mirror (not shown) and is optically coupled to PSR 216. The PSR 216 is optically coupled to an optical circuit 218 by a second waveguide 208B. In this example, the PSE 206 is oriented at a non-zero angle (e.g., 45 degrees) with respect to the PSR 216. In such an arrangement, the PSE 206 can be configured to emit a transverse magnetic optical field while the PSR 216 can be configured to receive a transverse electric optical field. Alternatively, the PSE 206 can be configured to emit a transverse electric optical field while the PSR 216 can be configured to receive a transverse magnetic optical field. In general, in order to achieve optical isolation, the optical mode emitted by the PSE 206 may be configured to be substantially orthogonal to the optical mode received by the PSR 216.

In some examples, a polarization-sensitive reflector can replace mirrors or other free-space optical elements so as to reduce the fabrication complexity and alignment requirements of a non-reciprocal optical element.

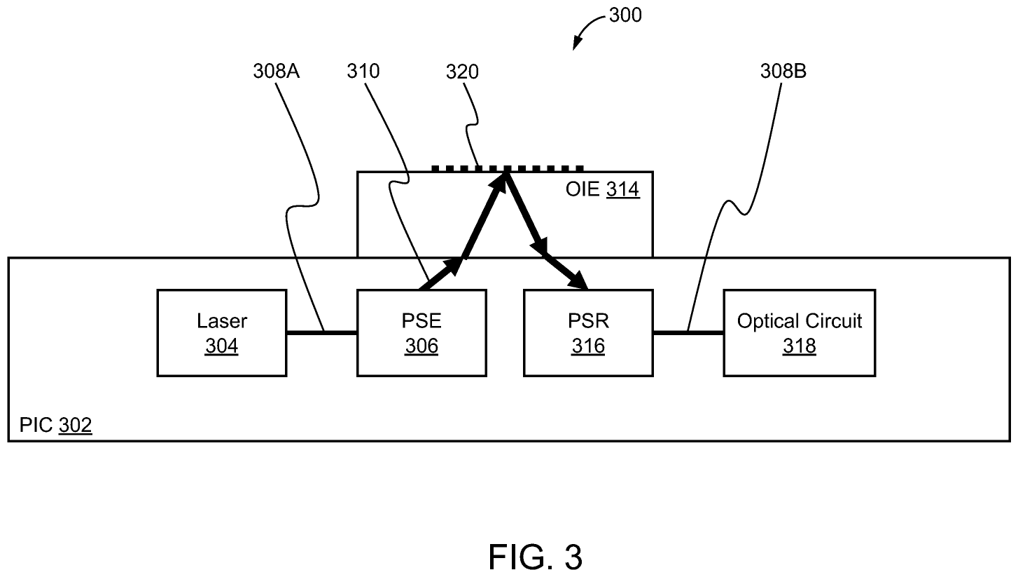

FIG. 3 shows a side view of an example OIPS 300 comprising a PIC 302. The PIC 302 comprises a laser 304 optically coupled to a PSE 306 by a first waveguide 308A. The PSE 306 emits free-space light 310 at a non-vertical angle that enters an OIE 314 that rotates the polarization of the free-space light 310 (e.g., by 45 degrees). The free-space light 310 then reflects off of a polarization-sensitive reflector 320 (e.g., a metal grating aligned with the polarization) and passes through the OIE 314 a second time, thereby further rotating the polarization of the free-space light 310 (e.g., by an additional 45 degrees). The polarization-sensitive reflector 320 is optically coupled to a PSR 316 located on the PIC 302. The polarization-sensitive reflector 320 can be designed, for example, such that light of a first polarization incident upon the polarization-sensitive reflector 320 is strongly reflected while light of a second polarization incident upon the polarization-sensitive reflector 320 is strongly absorbed. In such an arrangement, the PSE 306 can be configured to emit a transverse magnetic optical field while the PSR 316 can be configured to receive a transverse electric optical field. Alternatively, the PSE 306 can be configured to emit a transverse electric optical field while the PSR 316 can be configured to receive a transverse magnetic optical field.

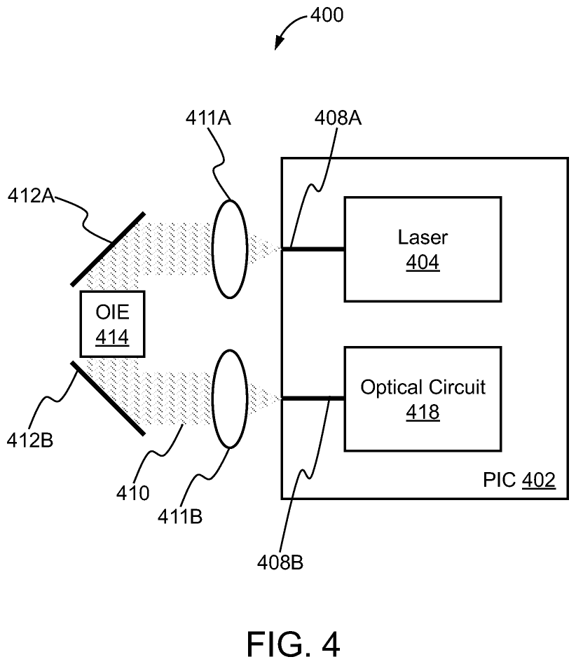

FIG. 4 shows a top view of an example OIPS 400 comprising a PIC 402. The PIC 402 comprises a laser 404 optically coupled to a first waveguide 408A that emits uncollimated free-space light 410 from a horizontal edge of the PIC 402. The free-space light 410 is then collimated by a first lens 411A and subsequently reflected off of a first mirror 412A and passes through an OIE 414. After the OIE 414, the free-space light 410 is reflected off of a second mirror 412B and is focused by a second lens 411B. The free-space light 410 is then optically coupled to a second waveguide 408B at a horizontal edge of the PIC 402, where the second waveguide 408B is optically coupled to an optical circuit 418. In this example, the laser 404 and the optical circuit 418 are located on the same PIC 402 (i.e., the same physical die), while the free-space coupled OIE 414 is located in proximity to the PIC 402. Collocating the laser 404 and the optical circuit 418 on the same PIC 402 may allow for reduced optical coupling loss (e.g., since the mode shapes exiting and entering the PIC 402 can be nearly identical). Additionally, the height above a layer of the PIC (e.g., a buried oxide layer) of both the first waveguide 408A and the second waveguide 408B can also be similar, thus allowing for simpler alignment of optical elements (e.g., the first mirror 412A and the second mirror 412B). The first mirror 412A and the second mirror 412B can optically couple the first waveguide 408A and the second waveguide 408B using a propagation path of the light that is substantially parallel the first waveguide 408A at one end and substantially parallel to the second waveguide 408B at another end, and that propagates through the OIE 414. For example, this can be accomplished by arranging a 45 degree angle of incidence at each mirror, or any other combination of angles that results in the free-space light 410 having substantially parallel propagation axes when traversing the first lens 411A and the second lens 411B. In other examples, the laser 404 and the optical circuit 418 can be located on different dies.

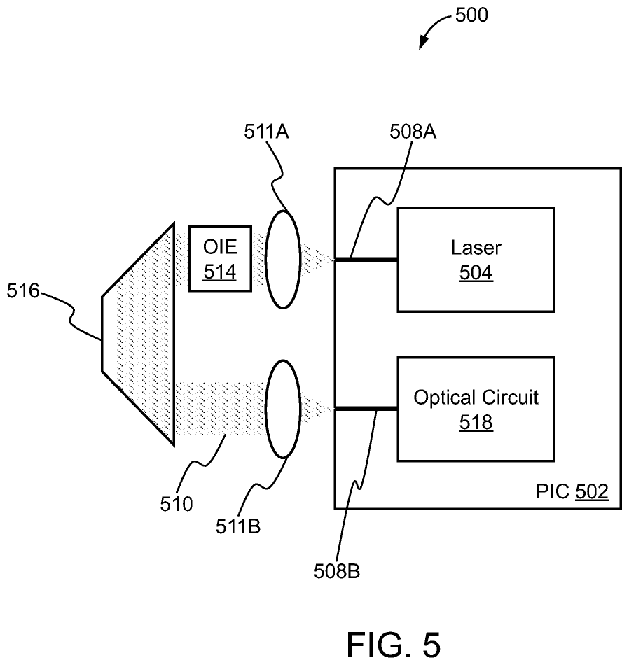

FIG. 5 shows a top view of an example OIPS 500 comprising a PIC 502. The PIC 502 comprises a laser 504 optically coupled to a first waveguide 508A that emits uncollimated free-space light 510 from a horizontal edge of the PIC 502. The free-space light 510 is then collimated by a first lens 511A, propagates through an OIE 514, and is subsequently reflected off of a prism 516 along a U-shaped path. The prism 516 may reduce alignment complexity compared to examples comprising two separate mirrors that perform a reflection along a U-shaped path. The free-space light 510 is then optically coupled to a second lens 511B which focuses the free-space light 510 and optically couples it to a second waveguide 508B at a horizontal edge of the PIC 502, where the second waveguide 508B is optically coupled to an optical circuit 518. In other examples, the OIE 514 can be placed between the prism 516 and the optical circuit 518, or can be integrated as part of the prism 516 itself.

In some examples, OIPS incorporate a passively-aligned OIE that is located on top of a portion of a PIC. For example, etching may be used to create trenches in one or more layers of the PIC so as to enable integration of an OIE with passive alignment to waveguides located on the PIC. Etching may be performed, for example, by utilizing silicon wet etching techniques with etchants such as tetramethylammonium hydroxide (TMAH) or potassium hydroxide (KOH). In some examples, the anisotropic wet etch rate of silicon selectively etches down to (111) planes (or symmetrically equivalent planes) of the silicon, enabling precise control of trench position and height based on the lithography mask utilized. The resulting polyhedral trenches can enable precise alignment of components with cylindrical or spherical symmetry, for example, as is done for passive alignment of fibers to waveguides in silicon v-grooves. Alternatively, an approximately polyhedral trench or any other set of two or more contact surfaces etched into the substrate and approximately aligned with crystallographic planes of the substrate can be used.

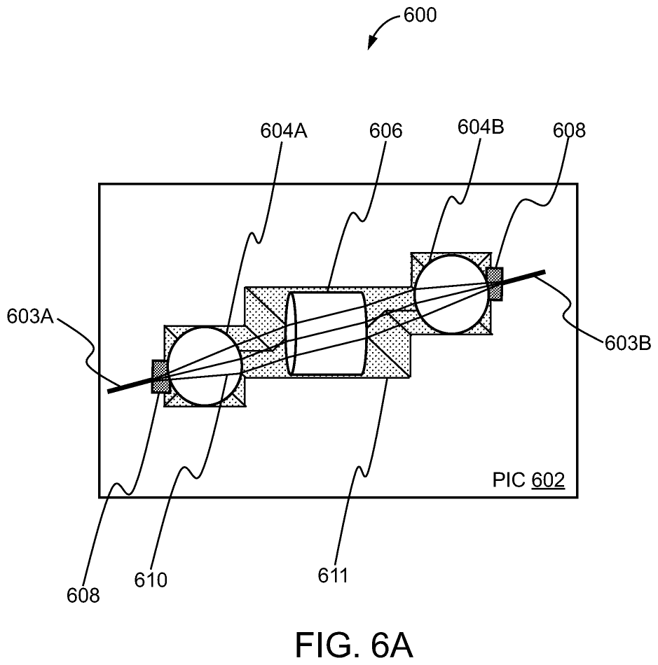

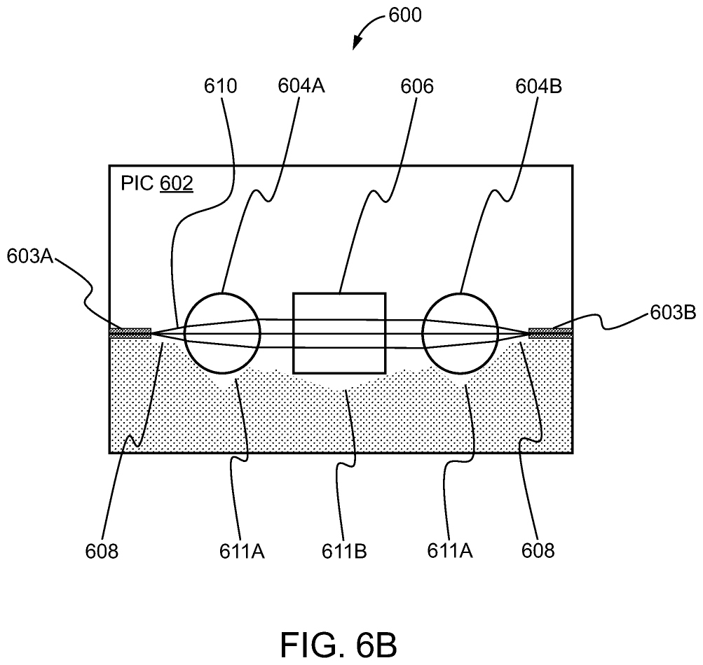

FIG. 6A shows a top view of an example OIPS 600 comprising a PIC 602. The PIC 602 comprises an input waveguide 603A optically coupled to a first ball lens 604A that collimates uncollimated free-space light 610 emitted by the input waveguide 603A. The free-space light 610 subsequently traverses an OIE. In some examples, the angle at which the free-space light 610 is incident upon one or more surfaces of the OIE 606 may be designed so as to reduce the effect of back-reflections. After traversing the OIE 606, the free-space light 610 is focused by a second ball lens 604B and is optically coupled to an output waveguide 603B. The first ball lens 604A, the second ball lens 604B, and the OIE 606 may each have an anti-reflection (AR) coating. Surface etched sections 608 are formed by performing a surface etch (i.e., an anisotropic, vertical dry etch) and are located under the input waveguide 603A and under the output waveguide 603B. The surface etching produces a vertical interface between air and the guided light mode that prevents the mode from refracting upwards or downwards and maintains the optical axis parallel to the surface of the PIC 602. Furthermore, the surface etched sections 608 also provide room for the input and output beams to expand before reaching the first ball lens 604A and the second ball lens 604B, since in some examples the waveguide facets are approximately placed at the respective focal planes of the ball lenses. A region etched pattern 611formed by region etching (i.e., a crystallographic wet etch process) comprises two pyramidal trenches for placement (i.e., mechanical support) of the first ball lens 604A and the second ball lens 604B, and one elongated trench for placement of the OIE 606. The OIE 606 may comprise one or more cylinders, rectangular prisms, and/or diamond prisms composed of a non-reciprocal material. In some examples, there can be one or more polarizers on the left and right sides of the OIE 606, or between two portions of the non-reciprocal material if more than one portion is utilized. If the non-reciprocal material is a magneto-optic material, external magnets (not shown) can be used to produce the Faraday rotation effect. Alternatively, any other type of magnetic field source can be used to apply a magnetic field in the vicinity of at least a portion of the non-reciprocal material. Furthermore, the input waveguide 603A and the output waveguide 603B may be dielectric waveguides fabricated within a lower index dielectric cladding layer on top of the PIC 602.

FIG. 6B shows a cross-sectional side view of the example OIPS 600 shown in FIG. 6A, where the cross-sectional plane intersects the center of the first ball lens 604A and the center of the second ball lens 604B. Region etching can be used to generate two pyramidal trenches 611A that allow for placement of the first ball lens 604A and the second ball lens 604B, as well as to generate an elongated trench 611B that allows for placement of the OIE 606. The size of the square openings on the left and right sides of the region etch mask may determine the vertical position of the first ball lens 604A and the second ball lens 604B with respect to a top surface of a PIC 602. The square openings may be sized such that the optical axis approximately intersects the center of the first ball lens 604A and the center of the second ball lens 604B. In some examples, the positioning of the OIE 606 may be less critical (e.g., one constraint may be that free-space light 610 is not clipped on the edges of the OIE 606). Using a lithographically defined region etch can enable fully passive optical element alignment, and assembly can proceed by using an adhesive to secure optical elements (e.g., the first ball lens 604A) in their natural resting positions. In general, the cross-sectional plane does not necessarily intersect the points of contact between the first ball lens 604A or the second ball lens 604B and their respective pyramidal trench 611A.

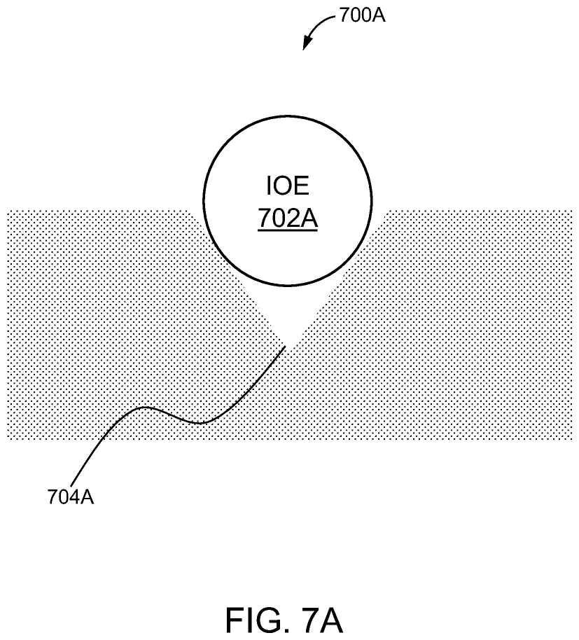

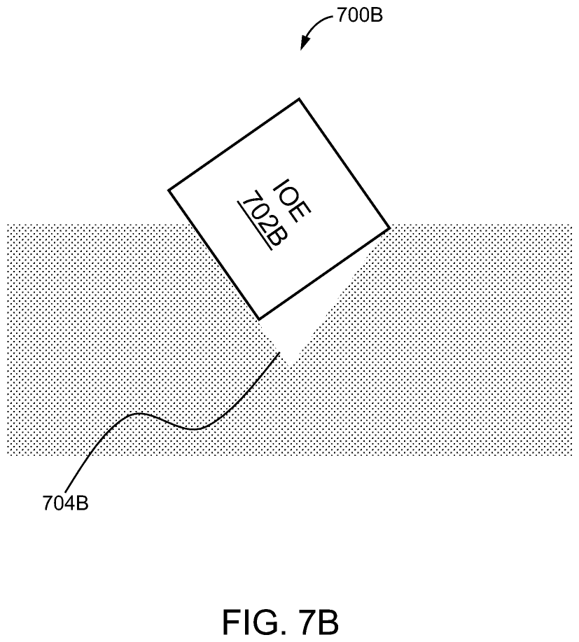

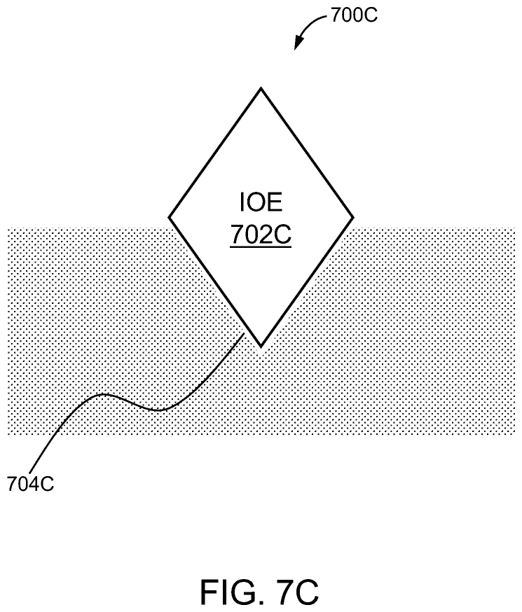

FIG. 7A shows a cross-sectional side view of a portion of an example OIPS 700A, where the cross-sectional plane intersects a cylindrical OIE 702A and is parallel to the two planar surfaces of the cylindrical OIE 702A upon which free-space light (not shown) is incident. Mechanical support for the cylindrical OIE 702A is provided by an etched trench 704A. In some examples, the cylindrical OIE 702A comprises polarizers and rotation alignment may be performed (e.g., during assembly) to align the polarizers (e.g., to the polarization of a transmitted optical wave).

In some examples, a rectangular prism OIE or a diamond prism-shaped OIE is utilized, and passive alignment can be achieved by resting one or more of the planar surfaces of the OIE against etched trench planes.

FIG. 7B shows a cross-sectional side view of a portion of an example OIPS 700B, where the cross-sectional plane intersects a rectangular prism OIE 702B and is parallel to the two planar surfaces of the rectangular prism OIE 702B upon which free-space light (not shown) is incident. Mechanical support for the rectangular prism OIE 702B is provided by an etched trench 704B which is contact with at least a portion of at least two different planar surfaces of the rectangular prism OIE 702B.

FIG. 7C shows a cross-sectional side view of a portion of an example OIPS 700C, where the cross-sectional plane intersects a diamond prism OIE 702C and is parallel to the two planar surfaces of the diamond prism OIE 702C upon which free-space light (not shown) is incident. Mechanical support for the diamond prism OIE 702C is provided by an etched trench 704C which is contact with at least a portion of at least two different planar surfaces of the diamond prism OIE 702C.

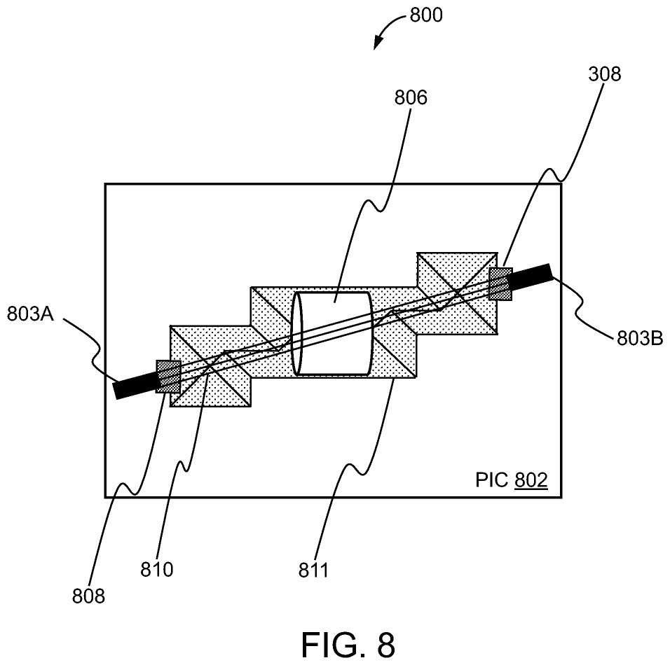

FIG. 8 shows a top view of an example OIPS 800 comprising a PIC 802. An input optical phased array 803A emits collimated free-space light 810 that subsequently propagates through an OIE 806. After traversing the OIE 806, the free-space light 810 is optically coupled to an output optical phased array 803B. Surface etched sections 808 are located under the input optical phased array 803A and under the output optical phased array 803B, and a region etched pattern 811 provides mechanical support for the OIE 806.

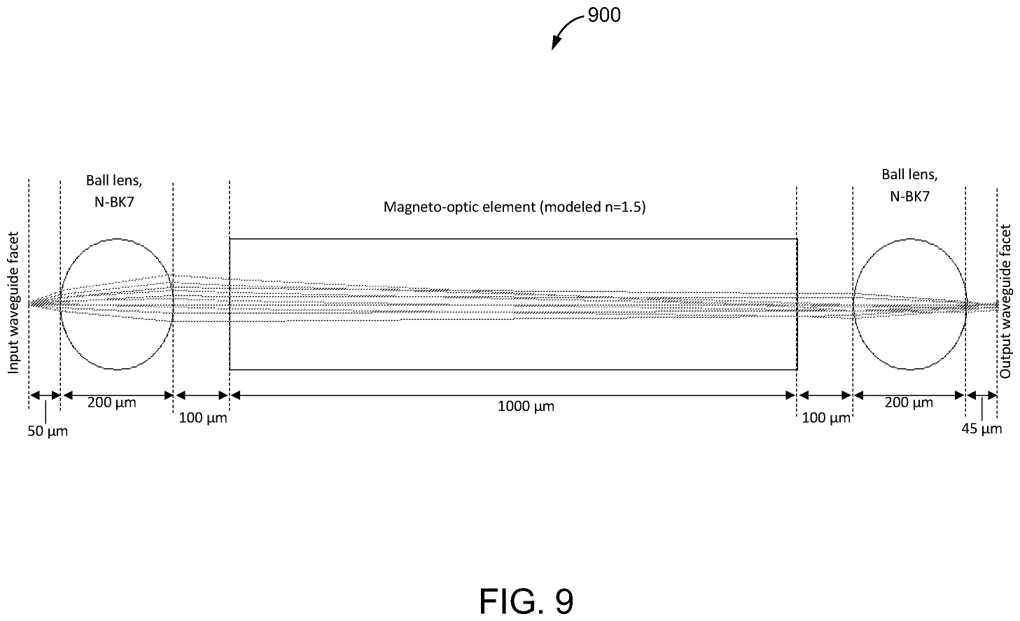

FIG. 9 shows a prophetic example of ray-tracing in an example OIPS 900, generated using OSLO-EDU software. Using the “fiber coupling efficiency” feature of OSLO based on Fourier transform diffraction, and Gaussian input and output modes with a 1/e² intensity beam waist of 3 μm, a facet-to-facet insertion loss of 1.0 dB was calculated when neglecting reflection at optical elements due to index mismatch, which can be reduced with anti-reflection coatings. Furthermore, the system is tolerant of a lateral offset of the two ball lenses of up to 2.5 μm while maintaining the overall insertion loss due to beam mismatch below 2.0 dB. Owing to the repeatability of the crystallographic silicon wet etch, this is a practically achievable level of alignment tolerance.

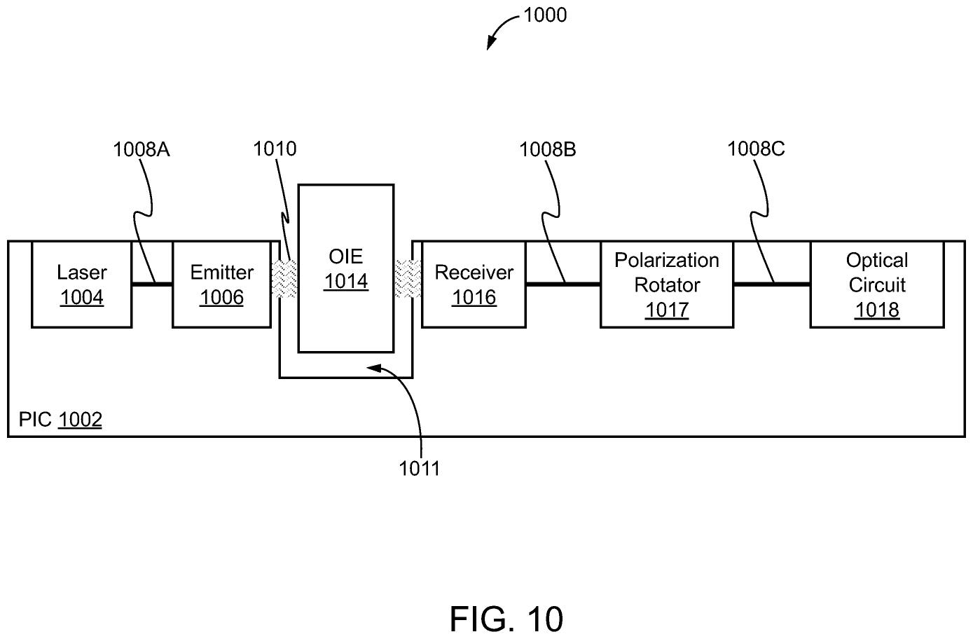

FIG. 10 shows an example OIPS 1000 comprising a PIC 1002. The PIC 1002 comprises a laser 1004 optically coupled to an emitter 1006 by a first waveguide 1008A. The emitter 1006 emits free-space light 1010 from a horizontal edge of the PIC 1002 and into a substrate trench 1011. The free-space light 1010 is optically coupled to an OIE 1014 that is located within the substrate trench 1011 and is subsequently received by a receiver 1016 located on the PIC 1002. The receiver 1016 is optically coupled to a polarization rotator 1017 (e.g., a reciprocal polarization rotator) by a second waveguide 1008B, and the polarization rotator 1017 is optically coupled to an optical circuit 1018 by a third waveguide 1008C. In some examples, the OIE 1014 comprises one or more non-reciprocal optical elements (e.g., Faraday rotators) that collectively rotate the free-space light 1010 by a multiple of 90 degrees (e.g., 90 degrees or 180 degrees), and at least one polarizer positioned to substantially transmit light coming from the emitter 1006 through the OIE 1014 and to substantially block any light reflecting back in the opposite direction. In such examples, receiving free-space light 1010 with a polarization that is parallel to one of the two rectangular cross-sectional dimensions of the receiver 1016 and/or of the second waveguide 1008B can reduce mode transfer (also referred to as mode mixing) between two or more modes (e.g., TM and TE modes) of the receiver 1016 and/or of the second waveguide 1008B. Such mode transfer can result in optical losses and interference between two or more modes, thus negatively impacting performance of downstream optical elements. Furthermore, the polarization rotator 1017 can provide additional rotation of light, and in some examples cancels the rotation of light performed by the OIE 1014 (e.g., such that light propagating in the third waveguide 1008C has a polarization that is similar to the polarization of the free-space light 1010 that is emitted by the emitter 1006). In some examples, the emitter 1006 and/or the receiver 1016 are configured to modify a mode diameter of light. For example, light with a first mode diameter that is coupled from the first waveguide 1008A to the emitter 1006 can be emitted by the emitter 1006 with a second mode diameter that is larger than the first mode diameter. Furthermore, light with a third mode diameter that is received by the receiver 1016 can be coupled to the second waveguide 1008B as light with a fourth mode diameter that is smaller than the third mode diameter.

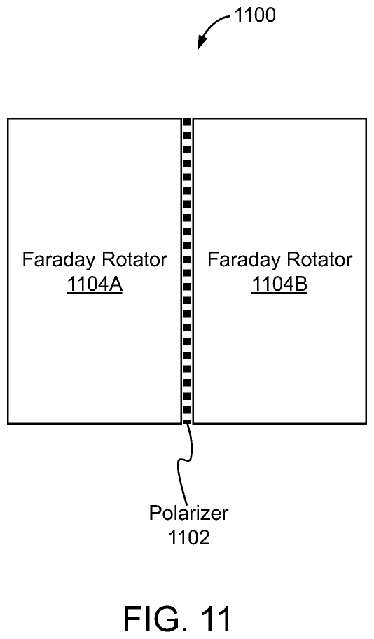

FIG. 11 shows an example OIE 1100 comprising a polarizer 1102 located between a first Faraday rotator 1104A and a second Faraday rotator 1104B. In some examples, the first Faraday rotator 1104A and the second Faraday rotator 1104B each rotate free-space light (not shown) by 45 degrees, and the polarizer 1102 is configured to transmit light that has a polarization of 45 degrees (e.g., such that incident free-space light with a polarization rotated by the first Faraday rotator 1104A is substantially transmitted through the polarizer 1102 and any reflected light propagating in the opposite direction from the receiver 1016 is rotated by an additional 90 degrees after forward and backward propagation through the Faraday rotator 1104B is substantially blocked by the polarizer 1102). Thus, the OIE 1100 rotates free-space light by 90 degrees by using two Faraday rotators, though in other examples three or more Faraday rotators may be used. Furthermore, the Faraday rotators do not necessarily have to rotate free-space light by equal amounts, so long as they collectively rotate free-space light by a multiple of 90 degrees, and the Faraday rotator after the polarizer 1102 rotates free-space light by 45 degrees on each of the forward and backward passes for a total rotation of 90 degrees to block any reflections at the polarizer 1102. The OIE 1100 may be used in the OIPS 1000 shown in FIG. 10 (e.g., as the OIE 1014 shown in FIG. 10).

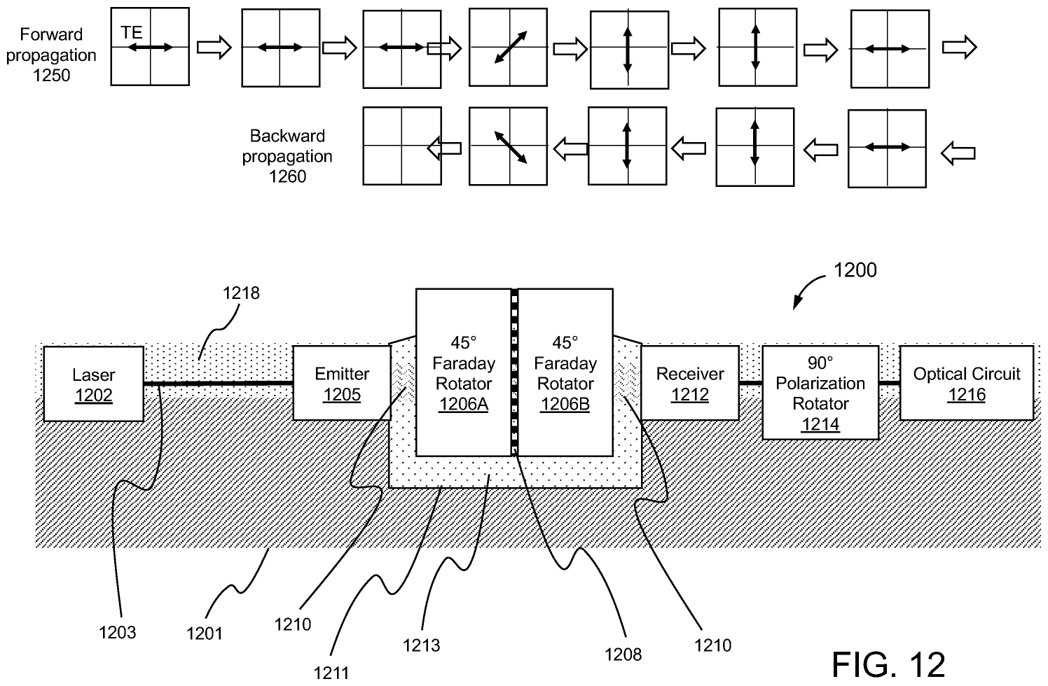

FIG. 12 shows an example OIPS 1200 that is similar to the OIPS 1000 using the OIE 1100 as the OIE 1014. There is also a set of polarization stage diagrams arranged to indicate the evolution of the polarization state in the forward propagation direction (1250) and the backward propagation direction (1260) at each stage of the cross-sectional view of the OIPS 1200. The OIPS 1200 comprises a PIC 1201. The PIC 1201 comprises a laser 1202 that provides an optical wave with transverse electric (TE) polarization (i.e., electric field lying in-plane with the PIC 1201), which is optically coupled using a waveguide 1203 on the PIC 1201 to a large mode-field diameter edge emitter 1205 integrated on the PIC 1201 enabling free-space optical propagation of a low divergence angle beam 1210 across the substrate trench 1211. A three-ply assembly comprised of a 45-degree Faraday rotator 1206A, 45-degree polarization filter 1208, and another 45-degree Faraday rotator 1206B is seated within the substrate trench 1211. The assembly rotates the polarization of the large mode-field diameter beam 1210 90-degrees before entering the large mode-field diameter edge coupler receiver 1212 integrated on the PIC 1201. The receiver 1212 is optically coupled to a 90-degree polarization rotator 1214 via a waveguide integrated on the PIC 1201. The 90-degree polarization rotator 1214 is optically coupled to an integrated optical circuit 1216 via another waveguide integrated on the PIC 1201. The three-ply assembly comprising the 45-degree Faraday rotator 1206A, 45-degree polarization filter 1208, and 45-degree Faraday rotator 1206B is bonded inside the trench 1211 using adhesive or epoxy 1213 with refractive index matched to an optical cladding 1218 of the PIC 1201. The polarization state after each stage of the propagation through these various elements integrated within the PIC 1201 is shown in both the forward propagation direction 1250 and the backward propagation direction 1260. As shown, after propagation in the backward direction 1260 through the 45-degree polarization filter 1208, the optical wave is substantially blocked due to its polarization being substantially orthogonal to the polarization axis of the filter 1208.

A variety of other features can be included in example OIPSs, including features that are facilitated by components and/or fabrication techniques that are designed for use with photonic integrated circuits.

In some examples OIPSs, a photonic chip can have a trench that separates on-chip counter-facing large mode-field diameter edge couplers that facilitate millimeter-scale propagation of light with low divergence angle. A non-reciprocal element can be placed into the trench and bonded with adhesive or epoxy with refractive index matched to optical cladding. In this arrangement, light emitted by one of the large mode-field diameter edge couplers passes through the non-reciprocal element with low divergence angle and is coupled to the second counter-facing large mode-field diameter edge coupler.

In some example OIPSs, a photonic chip with a polished 90-degree edge facet includes a single on-chip large mode-field diameter edge coupler that facilitate millimeter-scale propagation of light with low divergence angle. A non-reciprocal element can be placed onto the edge facet and bonded with adhesive or epoxy with refractive index matched to optical cladding. In this arrangement, light emitted by the large mode-field diameter edge coupler passes through the non-reciprocal element with low divergence angle and is reflected back and coupled to the large-mode-field diameter edge coupler using a polarization-dependent mirror.

Depending on the arrangement, a variety of on-chip elements can be used, such as polarization filters, 45-degree polarization rotators, 90-degree polarization rotators, or polarization splitter rotators. In some examples, the non-reciprocal element can comprise any of the following: a single 45-degree Faraday rotator, a two-ply combination of 45-degree Faraday rotators, a 45-degree polarization dependent mirror, a three-ply combination of: 45-degree Faraday rotator, a 45-degree polarization filter, and a 45-degree Faraday rotator. A trench can be formed in a substrate with sufficient geometric clearance to enable placement of the non-reciprocal element. The non-reciprocal element can have an anti-reflection coating and can be bonded to the substrate trench using index-matching epoxy. To form the non-reciprocal element, there can be a magnetic field source applying a magnetic field in the vicinity of at least a portion of the magneto-optical material, or there can be use of latched magneto-optical material that does not require external magnetic field.

A variety of potential advantages of such features can include one or more of the following. Free space propagation of low divergence angle light can be facilitated by large mode-field diameter edge couplers relaxes optical alignment tolerances. Bonding of non-reciprocal element to either the inside of a trench or to a polished edge facet does not require use of lensed elements and relaxes alignment tolerances and packaging complexity. On-chip counter-facing large mode-field diameter edge couplers fabricated during same fabrication stage are automatically aligned. Use of non-resonant large mode-field diameter edge couplers support broad optical bandwidth. Examples using 45-degree polarization rotating elements combined together on either side of a polarizing element to form a 90-degree polarization rotating element avoids use of single 45-degree polarization rotating elements that leave the polarization in a 45-degree polarization state, which can increase optical bandwidth. Additional example OIPSs in which such features can be included are described in more detail below.

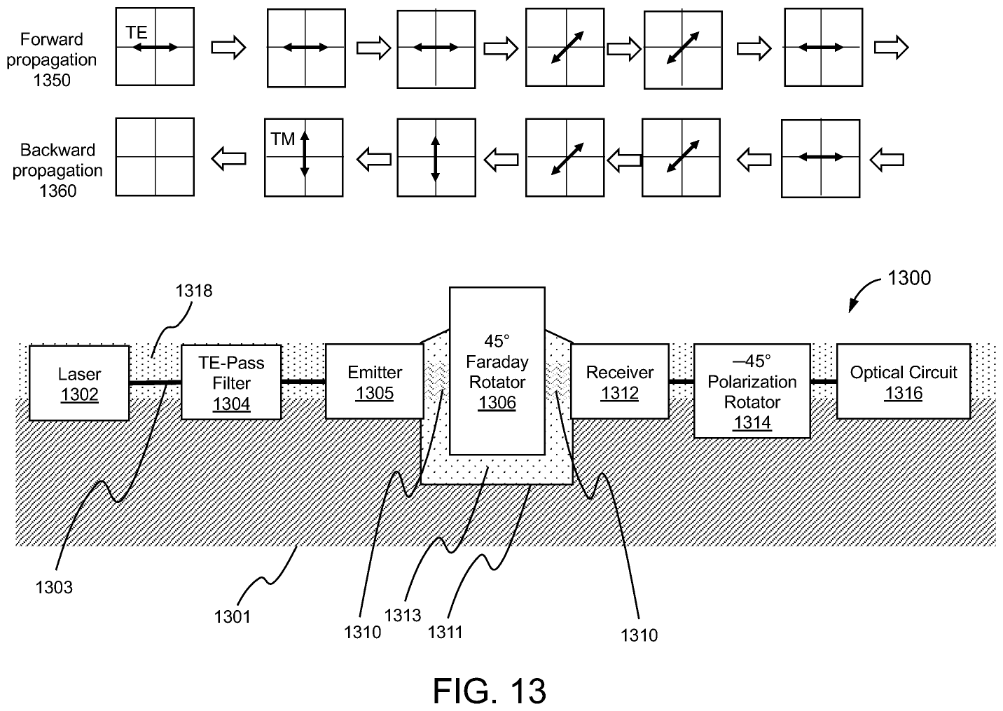

FIG. 13 shows an example OIPS 1300 comprising PIC 1301. The PIC 1301 comprises a laser 1302 that provides an optical wave with TE polarization, which is optically coupled using a waveguide 1303 on the PIC 1301 to a TE-pass filter 1304 allowing light of TE polarization (i.e., light with electric field polarization direction lying in-plane with the PIC 1301) to pass while blocking light with transverse magnetic polarization (TM) (i.e., light with magnetic field polarization direction lying in-plane with the PIC 1301). Light from the TE-pass filter 1304 is optically coupled using a waveguide on the PIC 1301 to a large mode-field diameter edge emitter 1305 enabling free-space optical propagation of a low divergence angle beam 1310 across a substrate trench 1311. A 45-degree Faraday rotator 1306 seated within the substrate trench 1311 rotates the polarization of the large mode-field diameter beam 1310 45-degrees before entering the large mode-field diameter edge coupler receiver 1312 integrated on the PIC 1301. The receiver 1312 is optically coupled to a 45-degree polarization rotator 1314 integrated on the PIC 1301 via a waveguide integrated on the PIC 1301. The 45-degree on-chip polarization rotator is optically coupled to an optical circuit 1316 integrated on the PIC 1301 via another waveguide integrated on the PIC 1301. The 45-degree Faraday rotator 1306 is bonded inside the trench 1311 using adhesive or epoxy 1313 with refractive index matched to an optical cladding 1318 of the PIC 1301. The polarization state after each stage of the propagation through these various elements integrated within the PIC 1301 is shown in both the forward propagation direction 1350 and the backward propagation direction 1360. As shown, after propagation in the backward direction 1360 through the TE-pass filter 1304, the optical wave is substantially blocked due to its polarization being substantially orthogonal to the polarization axis of the filter 1304.

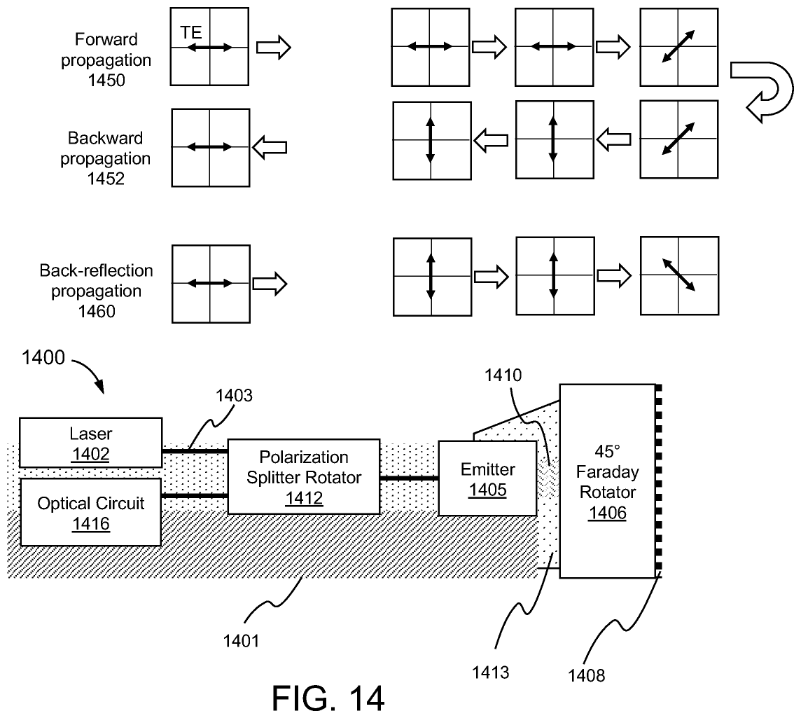

FIG. 14 shows a schematic diagram of an example OIPS 1400 comprising a PIC 1401. The PIC 1401 comprises a laser 1402 that provides an optical wave with TE polarization, which is optically coupled using a waveguide 1403 integrated on the PIC 1401 to a polarization splitter rotator 1412 allowing TE polarization to pass through. The polarization splitter rotator 1412 is optically coupled using a waveguide on the PIC 1401 to a large mode-field diameter edge emitter 1405 enabling free-space optical propagation of a low divergence angle beam 1410 across a 45-degree Faraday rotator 1406. A 45-degree polarization-dependent mirror 1408 reflects the low divergence beam 1410 back to the on-chip emitter 1405 (which also functions as a receiver in this example) with the polarization rotated 90 degrees (due to the double-pass through the 45-degree Faraday rotator 1406) thereby achieving a TM polarization state, as shown in the backward propagation direction 1452. The TM polarized light is optically coupled using a waveguide integrated on the PIC 1401 back to the polarization splitter rotator 1412 and is then optically coupled using another waveguide integrated on the PIC 1401 to an optical circuit 1416 integrated on the PIC 1401. The 45-degree Faraday rotator 1406 is bonded to a facet of the PIC 1401 by adhesive or epoxy 1413 with refractive index matched to an optical cladding of the PIC 1401. The polarization state after each stage of the propagation through these various elements integrated within the PIC 1401 is shown in both the forward propagation direction 1450 from the laser 1402 to the 45-degree Faraday rotator 1406, the backward propagation direction 1452 from the 45-degree Faraday rotator 1406 to the optical circuit 1416, and from the back-reflection propagation path 1460 from the optical circuit 1416 to the 45-degree Faraday rotator 1406. As shown, at the end of the back-reflection propagation path 1460, the optical wave is substantially blocked due to its polarization being substantially orthogonal to the polarization axis of the 45-degree polarization-dependent mirror 1408.

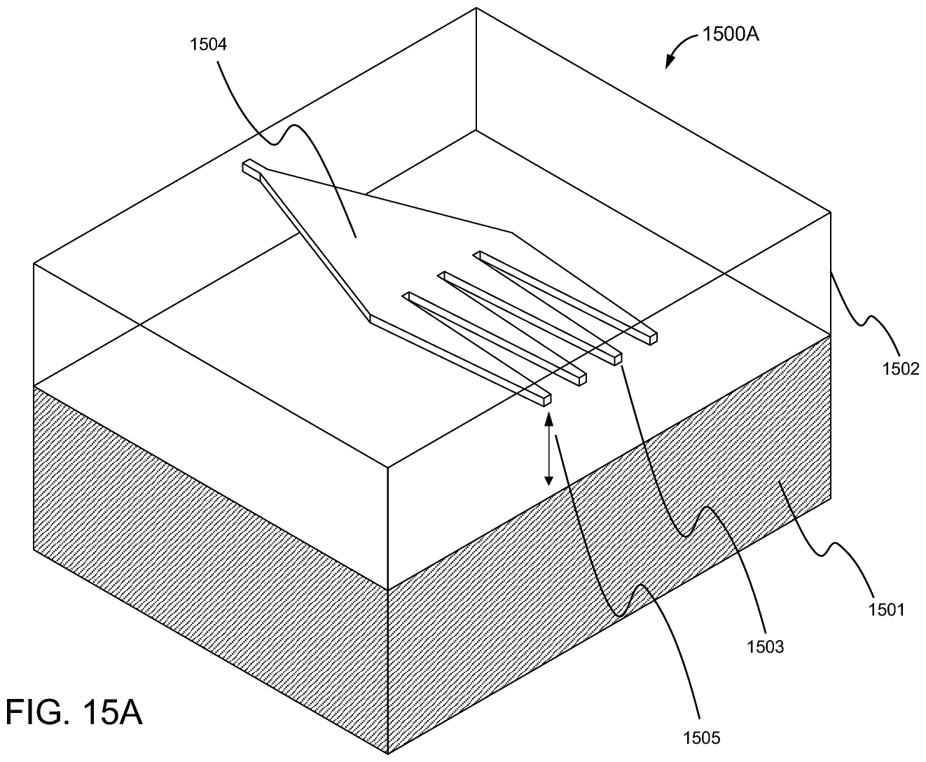

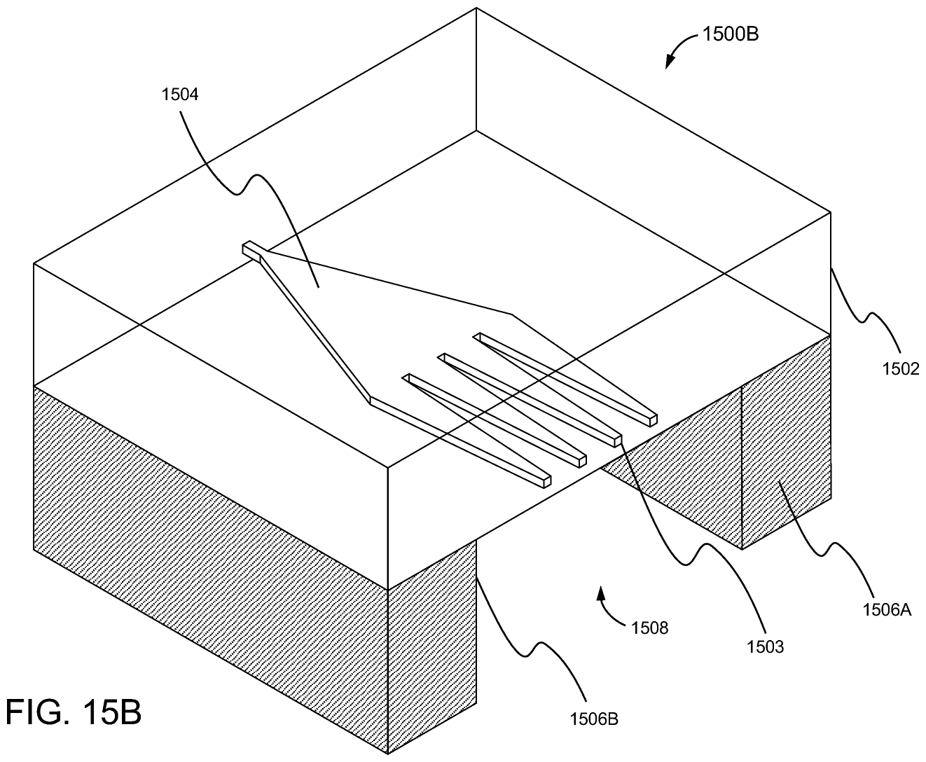

FIG. 15A shows an axonometric view of a large mode-field diameter edge coupler 1500A on a high refractive index substrate 1501 with low refractive index optical cladding 1502. An edge coupler portion 1503 comprises a facet comprising a low duty cycle array of narrow waveguides with refractive index higher than the optical cladding 1502. The low duty cycle waveguide array relaxes the confinement of light confinement enabling expansion of the optical mode. An integrated mode converter portion 1504 enables routing to waveguides of the edge coupler portion 1503. To reduce substrate losses due to the increased mode field diameter, a sufficiently large distance 1505 from the edge coupler portion 1503 to the high refractive index substrate 1501 is used.

FIG. 15B shows an axonometric view of a large mode-field diameter edge coupler 1500B with high refractive index substrate portions 1506A and 1506B and the low refractive index optical cladding 1502 surrounding the mode converter portion 1504 and edge coupler portion 1503. In this example, to avoid substrate losses due to the increased mode field diameter, the high refractive index substrate can be undercut to form a void 1508 that can be backfilled with adhesive or epoxy with refractive index matched to the optical cladding 1502.

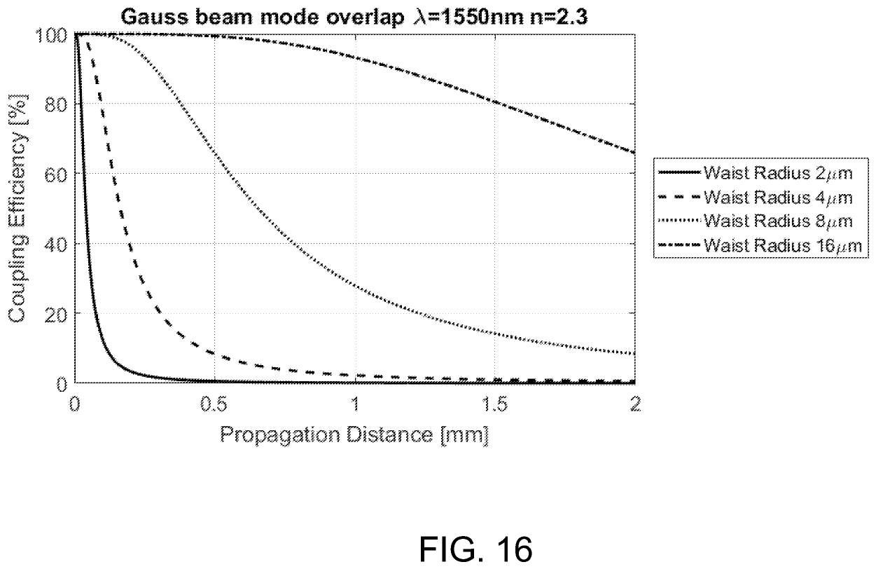

FIG. 16 shows a plot of a prophetic example of the coupling efficiency of two Gaussian optical beams of varying width as a function of distance. A large mode field diameter is useful to achieve low coupling loss across millimeter scale distances.

An OIPS can be implemented on an integrated circuit (e.g., a die that has been fabricated by processing a wafer and dicing the wafer into multiple dies) as an apparatus that has any of the following characteristics.

In one aspect, in general, an apparatus comprises: (a) large mode-field diameter edge couplers to enable millimeter-scale free-space propagation of optical radiation with low divergence angle of either polarization; and (b) a pair of counter-facing large mode-field diameter edge couplers fabricated on the same photonic die during the same process step to mitigate the need for alignment of edge couplers. One of the edge couplers can be connected to an integrated 45-degree polarization rotator. The other edge coupler can be connected to an integrated filter allowing transverse electric polarization to pass through and block the transverse magnetic polarization. The apparatus also comprises: (c) a trench formed between the counter-facing large mode-field diameter edge couplers deeper than mode-field diameter, and (d) magneto-optical (MO) material comprising any of the following: (i) MO material fabricated in separate fabrication process, (ii) MO material of required thickness to rotate polarization 45degrees about the propagation axis at the central wavelength, and/or (iii) MO material that contains anti-reflection coatings matched to refractive index of bonding epoxy. The apparatus also has the MO material placed inside the trench and bonded to the die using epoxy with refractive index matched to low refractive index optical cladding to mitigate scattering and reflection of light (e.g., oxide).

In another aspect, in general, an apparatus comprises: (a) large mode-field diameter edge couplers to enable millimeter-scale free-space propagation of optical radiation with low divergence angle of either polarization; and (b) a pair of counter-facing large mode-field diameter edge couplers fabricated on the same photonic die during the same process step to mitigate the need for alignment of edge couplers. One of the edge couplers can be connected to an integrated 90-degree polarization rotator. The other edge coupler can be connected to an integrated filter allowing transverse electric polarization to pass through and block the transverse magnetic polarization. The apparatus also comprises a trench formed between the counter-facing large mode-field diameter edge couplers deeper than a mode-field diameter. The apparatus also comprises a three-ply material with any of the following properties to avoid the use 45-degree polarization rotator that can limit operating range of wavelengths: plies in the following order (1) MO material, (2) polarization filter, and (3) MO material; both MO materials fabricated in separate fabrication process; both MO materials of thickness to rotate polarization 45 degrees about the propagation axis at the central wavelength; polarization filter aligned 45 degrees with respect to the direction of transverse electric field; and/or anti-reflection coating(s) matched to a refractive index of a bonding epoxy. The apparatus can also comprise a three-ply material placed inside a trench and bonded to the die using epoxy with refractive index matched to low refractive index optical cladding to mitigate scattering and reflection of light (e.g., oxide).

In another aspect, in general, an apparatus comprises: (a) a large mode-field diameter edge coupler to enable millimeter-scale free-space propagation of optical radiation with low divergence angle of either polarization; (b) a large mode-field diameter edge coupler connected to an integrated polarization splitter rotator to allow polarization-dependent routing of light entering the large mode-field diameter edge coupler; (c) a facet of a large mode-field diameter edge coupler polished 90 degrees to the chip plane; and (d) a two-ply material with any of the following properties to avoid the use 45-degree polarization rotator that can limit operating range of wavelengths: plies in the following order (1) MO material, (2) polarization-dependent mirror; MO material fabricated in separate fabrication process; MO material of thickness to rotate polarization 45 degrees about the propagation axis at the central wavelength; MO material may contain anti-reflection coatings matched to refractive index of bonding epoxy; and/or a polarization-dependent mirror designed to allow reflection of light polarized 45 degrees with respect to the direction of transverse electric field. The apparatus also comprises (e) a two-ply material bonded to 90-degree polished edge facet using bonded to die using epoxy with refractive index matched to low refractive index optical cladding to mitigate scattering and reflection of light (e.g., oxide).

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a photonic integrated circuit comprising a first optical coupler coupled to an optical source and a second optical coupler coupled to one or more photonic circuit elements integrated in the photonic integrated circuit; and
a non-reciprocal optical element optically coupled to the first optical coupler and the second optical coupler;
wherein at least one of the first optical coupler or the second optical coupler is configured as a polarization-sensitive optical antenna that has an angular radiation function comprising at least (1) a peak intensity of a transverse magnetic optical field associated with a first angular direction, and (2) a peak intensity of a transverse electric optical field associated with a second angular direction different from the first angular direction.

2. The apparatus of claim 1, wherein the non-reciprocal optical element comprises a magneto-optic material.

3. The apparatus of claim 2, further comprising a magnetic field source applying a magnetic field in the vicinity of at least a portion of the magneto-optical material.

4. The apparatus of claim 1, wherein
the first optical coupler is configured as a polarization-sensitive transmitting optical antenna that has an angular radiation function comprising at least (1) a peak intensity of a transverse magnetic optical field associated with transmitting in a first angular direction, and (2) a peak intensity of a transverse electric optical field associated with transmitting in a second angular direction different from the first angular direction; and
the second optical coupler is configured as a polarization-sensitive receiving optical antenna that has an angular radiation function comprising at least (1) a peak intensity of a transverse magnetic optical field associated with receiving in a first angular direction, and (2) a peak intensity of a transverse electric optical field associated with receiving in a second angular direction different from the first angular direction.

5. The apparatus of claim 1, wherein the first optical coupler comprises a first optical phased array, and the second optical coupler comprises a second optical phased array.

6. The apparatus of claim 5, wherein the first optical phased array comprises a plurality of optical gratings coupled to respective phase shifters.

7. An apparatus comprising:
a photonic integrated circuit comprising a first optical coupler coupled to an optical source and a second optical coupler coupled to one or more photonic circuit elements integrated in the photonic integrated circuit;
a non-reciprocal optical element; and
a reflecting optical arrangement comprising at least two reflecting surfaces, wherein
the reflecting surfaces are all mechanically secured relative to each other, and
the reflecting surfaces are arranged to optically couple the first optical coupler and the second optical coupler using an optical wave propagation path that is substantially parallel the first optical coupler at one end and substantially parallel to the second optical coupler at another end, and that propagates through the non-reciprocal optical element.

8. The apparatus of claim 7, wherein the non-reciprocal optical element comprises a magneto-optic material.

9. The apparatus of claim 8, further comprising a magnetic field source applying a magnetic field in the vicinity of at least a portion of the magneto-optical material.

10. The apparatus of claim 7, wherein the reflecting optical arrangement comprises at least two mirrors mounted to a common rigid structure.

11. The apparatus of claim 7, wherein the reflecting optical arrangement comprises at least one prism.

12. An apparatus comprising:
a non-reciprocal optical element;
a first lens;
a second lens; and
a photonic integrated circuit comprising a substrate having an etched cavity configured to include
a first etched portion shaped to mechanically support the first lens using a set of two or more contact surfaces etched into the substrate approximately aligned with crystallographic planes of the substrate,
a second etched portion shaped to mechanically support the second lens using a set of two or more contact surfaces etched into the substrate approximately aligned with crystallographic planes of the substrate, and
a third etched portion shaped to mechanically support at least a portion of the non-reciprocal optical element.

13. The apparatus of claim 12, wherein the non-reciprocal optical element comprises a magneto-optic material.

14. The apparatus of claim 13, further comprising a magnetic field source applying a magnetic field in the vicinity of at least a portion of the magneto-optical material.

15. The apparatus of claim 12, wherein the substrate comprises silicon.

16. An apparatus comprising:
a photonic integrated circuit comprising a first optical coupler coupled to an optical source and a second optical coupler coupled to one or more photonic circuit elements integrated in the photonic integrated circuit; and
an optically isolating element coupled to the first optical coupler and to the second optical coupler, the optically isolating element comprising
one or more non-reciprocal optical elements that collectively rotate a polarization of light by a multiple of 90 degrees, and
at least one polarizer.

17. The apparatus of claim 16, wherein the optically isolating element is at least partially located within a substrate trench of the photonic integrated circuit.

18. The apparatus of claim 16, wherein the one or more non-reciprocal optical elements comprise a first Faraday rotator that rotates a polarization of light by 45 degrees, a second Faraday rotator that rotates a polarization of light by 45 degrees, and the at least one polarizer is located between the first Faraday rotator and the second Faraday rotator.

19. The apparatus of claim 16, wherein at least one of the first optical coupler or the second optical coupler are configured to modify a mode diameter of light.

20. The apparatus of claim 16, further comprising a polarization rotator, coupled to the second optical coupler, that rotates a polarization of light.
